(19) United States
(12) Patent Application Publication
(10) Pub. No.: US 2014/0117676 A1
(43) Pub. Date: May 1, 2014

(54) Generator Unit for an Agricultural or Communal Commercial Vehicle

(71) Applicants: Manuel Goetz, Ravensburg (DE); Johannes Ziegler, Trochtelfingen (DE); Martin Sagmeister, Passau (DE); Mark Mohr, Tettnang (DE)

(72) Inventors: Manuel Goetz, Ravensburg (DE); Johannes Ziegler, Trochtelfingen (DE); Martin Sagmeister, Passau (DE); Mark Mohr, Tettnang (DE)

(73) Assignee: ZF Friedrichshafen AG, Friedrichafen (DE)

(21) Appl. No.: 14/128,763

(22) PCT Filed: May 4, 2012
(86) PCT No.: PCT/EP2012/058186

§ 371 Date: Dec. 23, 2013

(30) Foreign Application Priority Data
Jun. 28, 2011 (DE) 10 2011078 192.7

(51) Int. Cl. H02K 7/00

(52) U.S. Cl. CPC H02K 7/006
USPC 290/1 R

(57) ABSTRACT

The invention relates to a generator unit (1; 31) for an agricultural or municipal commercial vehicle, in particular a tractor, comprising a generator housing (2; 35) and at least one shaft (3), which is passed in a rotating manner through the generator housing (2; 35) and forms a coupling (4) for a power take-off shaft (23) of the commercial vehicle at the first end, while a port (5) for an input shaft of an add-on device is defined through at least one shaft (3) at a second end. At least one electrical generator (6; 32), which is able to be driven through at least one shaft (3), is incorporated in the generator housing (2; 35). In order to then be able to provide for a powerful generator and, at the same time, use a power lift (19) of the commercial vehicle, a mounting device is also provided; this is connected to the generator housing and, on the part of the first end of at least one shaft (3), forms mounting points (25, 26, 27) for connecting to suspension devices of the power lift (19) of the commercial vehicle, whereas the mounting device, on the part of the second end of at least one shaft (3), possesses connection points (28, 29, 30) for the incorporation of the add-on device. Thereby, the connection points (28, 29, 30) of the mounting device correspond to the suspension devices of the power lift (19) in form and alignment.

The invention relates to a generator unit for an agricultural or municipal commercial vehicle, in particular a tractor, comprising a generator housing and at least one shaft, which is passed in a rotating manner through the generator housing and forms a coupling for a power take-off shaft of the commercial vehicle at the first end, while a port for an input shaft of an add-on device is defined through at least one shaft at a second end, whereas at least one electrical generator, which is able to be driven through at least one shaft, is incorporated in the generator housing.

Agricultural or municipal commercial vehicles typically have suspension devices to which add-on devices for carrying out certain work activities may be attached. Thus, a tractor features corresponding hitching points both on the front side and the rear side; these are formed at least on the rear side as power lifts for lifting the particular hooked up add-on device. Conventionally, the mechanical drive the respective add-on device is effected through a power take-off shaft of the tractor.

In stationary applications (among other things), stationary generator units are also used; these are not attached and, for parked commercial vehicles, are operated mechanically via the power take-off shaft of commercial vehicles, in order to, for example, for a power source as an emergency generator for agricultural equipment. In addition to any such stationary use, mobile generator units are also used; these provide power as one unit attached to the commercial vehicle, even when the commercial vehicle is being used. These mobile generator units are likewise driven via the respective power take-off shaft of the commercial vehicle, and deliver corresponding power for other add-on devices attached to the respective commercial vehicle.

DE 103 03 050 84 shows such a mobile generator unit for an agricultural commercial vehicle, such as a tractor, whereas this generator unit possesses a generator housing that may be attached non-rotatably to a vehicle frame of the commercial vehicle and that incorporates an input shaft and an output shaft in a pivoting manner. Thereby, the input shaft, when attached to the generator unit, is connected to a power take-off shaft of the commercial vehicle, whereas the output shaft is connected to the input shaft based on the drive, and in further course may be connected to an input shaft of an add-on device of the commercial vehicle. Subsequently, a rotary movement of a power take-off shaft of the commercial vehicle is transmitted to the input shaft, and then, further on, to the output shaft, of the generator unit, through which a further add-on device attached to the commercial vehicle is then able to be mechanically driven. An electrical generator with a rotor is also incorporated in the generator housing, whereas the rotor is connected to the input shaft of the generator unit, such that electric current is made available upon the rotation of the input shaft. Thereby, electrical loads (such as, for example, electrical drives) of the add-on device to be hitched as an addition to the mobile generator unit can also be operated with higher rated voltages, as an on-board electrical system of the commercial vehicle is usually available.

Starting from the state of the art described in the preceding, the task of the present invention is to form a generator unit for an agricultural or municipal commercial vehicle, in which high-performance and correspondingly large-scale electrical generators can be used, but at the same time continuing to make available a power lift for additional add-on devices.

This task is solved based on the preamble of claim 1 in connection with its identifying characteristics. Each of the following dependent claims reflects another advantageous form of the invention.

In accordance with the invention, a generator unit for an agricultural or municipal commercial vehicle comprises a generator housing and at least one shaft, which is passed in a mounted manner through the generator housing and forms a coupling for a power take-off shaft of the commercial vehicle at the first end. Furthermore, at least one shaft at a second, opposing end defines a port, through which a connection to an input shaft of a further add-on device attached to the commercial vehicle can be produced. Finally, at least one electrical generator, which is able to be driven through at least one shaft, is incorporated in the generator housing.

In terms of the invention, both the coupling for the power take-off shaft of the commercial vehicle and the port for the input shaft of the add-on device are formed at ends of a single shaft, which is then passed through the generator housing. Alternatively, both connection points may be provided, by at separate shafts, which are then coupled with one another within the generator housing. Thereby, a coupling for the power take-off shaft is preferably formed as a shaft section with an internal toothing corresponding to the power take-off shaft, whereas, depending on the profile of the power take-off shaft, the toothing may thereby be provided with spline shaft toothing or involute profile toothing. By contrast, the port for the input shaft on the second side of the generator is formed in particular with a profile corresponding to the contour of the power take-off shaft, such that the input shaft of the add-on device may be connected to the port on the generator unit in the same manner that it would also be directly coupled with the power take-off shaft of the commercial vehicle. Finally, more than one electrical generator may be incorporated in the generator housing, whereas if there are several generators, these may also make available (if necessary) power with different rated voltages.

The invention then comprises the technical character that amounting device is also provided; this is connected to the generator housing and, on the part of the first end of at least one shaft, forms mounting points for connecting to suspension devices of the power lift of the commercial vehicle, whereas the mounting device, on the part of the second end of at least one shaft, possesses connection points for the incorporation of the add-on device. Thereby, the connection points of the mounting device correspond to the suspension devices of the lifting gear in form and alignment. In other words, the generator unit in accordance with the invention has a mounting device that is formed in such a way that, on a first side of the generator housing facing the power lift of the commercial vehicle, a connection to the power lift is able to be presented, and, on a second side of the generator housing facing the add-on device, a mounting of an add-on device may be effected on the mounting device. Thereby, the connection points on the part of the add-on device are carried out such that a suspension corresponding to the power lift is formed. By means of such an implementation of a generator unit, it is possible to also provide high-performance and thus large-scale electrical generators, and despite the larger generator housing that this creates, nevertheless to be able to use the power lift of the commercial vehicle for the additional connection of an add-on device. This is because, through providing the mounting device, one element is interposed; this, on the one hand, presents the connection of the generator unit to the power lift and, on the other hand, forms a mounting that corresponds to the power lift for the additional add-on device. Thus, this allows for a simultaneous formation of a sufficient intermediate space between the power lift and the add-on device for the placement of a large generator housing, yet nonetheless a guiding of an add-on device downstream from the generator unit. As a whole, without sacrificing functionality, an integration of one or more high-performance electrical generators may be realized between the power lift and the add-on device.

In contrast to this, DE 103 03 050 84 may apply to only a small constructed generator; nevertheless, in order to be able to provide an additional add-on device to a power lift of the commercial vehicle provided there. This is because, upon the use of a larger generator with more power, the space requirement of the generator unit is too large, such that a direct hitching of the additional add-on device to the power lift becomes impossible. On the part of the generator unit, no corresponding connection points for being able to mount the add-on device are formed.

According to one advantageous embodiment of the invention, the mounting device is carried out as a support frame with a triangular form, which, in the area of the corner points, is provided with one mounting point each in the form of one mounting pin each and with one connection point each aligned opposite to the respective mounting point in the form of one mounting hook each, whereas the mounting pins correspond to the suspension devices in the form of arresting hooks, and the mounting hooks correspond to the arresting hooks in form and alignment. By the means of the arrangement of the mounting device as a support frame, which, through its triangular form and the placement of connection points at corners, adjusts the suspension devices of a three-point power lift of the commercial vehicle, a durable link between the power lift and the respective add-on device may be formed.

In an additional form of the invention, the mounting points and the connection points are formed as detachable individual elements of the mounting device. Thereby, the individual elements forming the mounting points for connecting the power lift and the individual element defining the connection points for mounting the add-on device may be preferably exchanged in terms of their arrangement in the generator housing, such that the generator housing may be attached with both of its sides at the power lift oriented to the commercial vehicle. Thereby, the direction of rotation of a rotor of the electrical generator may be adjusted to the direction of rotation of the power take-off shaft of the commercial vehicle, by the generator housing being correspondingly arranged on the commercial vehicle and a correspondingly oriented initiation of a rotary movement through the power take-off shaft in at least one shaft of the generator unit taking place. In terms of the invention, the individual elements are thereby carried out in particular as individual parts that may be connected with screws to the remaining components of the mounting device in the form of mounting pins and mounting hooks; these are then fastened in the desired position to the generator housing or a support frame. At least one shaft may be carried out as a stub shaft, which, depending on the alignment of the generator housing, may be passed through the housing on a varying basis. It is also conceivable to form the mounting points and the connection points adjustable to the mounting device regarding their position, such that an adjustment to the fastening points of the power lift and the add-on device may be undertaken.

In accordance with a further arrangement of the invention, the mounting device is carried out as a separate component, to which the generator housing is attached. Through this measure, the mounting device may be made from different material than that of the generator housing, such that a sufficient load capacity with regard to the add-on device to be attached may be easily shown. Thus, the mounting device may be made of steel, while the generator housing is made from cast material. Furthermore, a simple adjustment of the direction of rotation of a respective rotor of the electrical generator in the direction of rotation of the power take-off shaft of the commercial vehicle may also be undertaken, by simply reversing the generator housing with regard to its orientation to the mounting device with a detachable connection between the generator housing and mounting device. However, in principle, a one-piece design of the mounting device and the generator housing is also conceivable.

In an additional form of the invention, a gear is provided between at least one shaft and at least one electrical generator; through this, a rotary movement of at least one shaft is able to be transmitted to one rotor of at least one generator each. Through this measure, the rotation speed of the respective rotor of at least one generator may be optimally adjusted to the power take-off shaft rotation speed, with which at least one shaft runs. In particular, compact-constructed high-speed electrical generators may be used for this. In terms of the invention, each gear may thereby be carried out as a spur-gear stage, a planetary stage or a belt or chain drive. It is also conceivable to, through a corresponding design of each gear make possible a targeted switching of at least one generator, such that electricity generation through the generator takes place only at specific, desired operating situations. Thereby, this switching may be initiated (if applicable) through a higher-level control system or purposefully by the driver of the vehicle.

According to a further, advantageous embodiment of the invention, a control electronics unit is provided; this connects to at least one generator. Thereby, this control electronics unit preferably comprises a power electronics unit, through which at least one generator is able to be controlled, whereas this power electronics unit may be housed either in the generator housing, or incorporated in a housing that is separate but structurally connected to the generator housing. Through the power electronics unit, the targeted control of at least one electrical generator is then undertaken, and (if applicable) the monitoring of parameters of the generator, such as temperature, etc., is also shown, Furthermore, through such a power electronics unit, the electrical switching of at least one generator may also be controlled, such that, similar to the mechanical switching of the aforementioned variant, this is driven, and electricity is generated, only in certain situations.

Advantageously, the control electronics unit thereby has a control device, which governs at least one generator and is connected to a data interface. Through this data interface, a connection to a control system of the commercial vehicle and/or the add-on device may be undertaken, and a governing of the generator may be accordingly undertaken on the part of the vehicle or the part of the add-on device. Thereby, it is also conceivable to initiate a software-based adjustment of the rotary movement of a rotor of at least one generator to the respective power take-off shaft rotation speed via the data interface. However, as an alternative to this, a corresponding switch or a control element may be provided in the area of the generator housing; upon the actuation of this, the aforementioned adjustment to the direction of rotation of the power take-off shaft may be initiated. Furthermore, in addition to the data interface, a power connection point may also be provided, through which the control electronics unit may be supplied with energy through the on-board electrical system of the commercial vehicle or the add-on device, such that the functioning of the control electronics unit is ensured, even upon a lack of power supply through at least one electrical generator. However, within the framework of the invention, a stand-alone operation of the control electronics unit, and thus also at least one generator, without a connection to the commercial vehicle or the add-on device, is also possible.

In an additional form of the invention, at least one generator is connected to at least one output interface, Through the one or more output interfaces, a supply of electrical devices and/or actuators can then be ensured, particularly on the part of the add-on device. Thereby, the generator may either be connected directly to the respective output interface, such that AC voltage with generator frequency is accessible on this output interface, but it is also conceivable to interpose a rectifier under the generation of DC voltage and provide one or more inverters built on an intermediate DC circuit, such that AC voltage with a frequency not equal to generator frequency is accessible. Moreover, a DC/DC converter may also be provided, such that at least one generator itself produces supply voltage for components, such as, for example, the control electronics unit. Thereby, such a DC/DC converter can also be downstream from an output interface, such that an electrical supply of the add-on device may be undertaken with an electrical voltage at a defined voltage level, such as 12 or 24 volts. Finally, it is also conceivable to provide a low-voltage battery, such that the power supply of components of the generator unit is ensured, even with a standing generator.

In accordance with a further arrangement of the invention, a cooling system is provided. Within the framework of the invention, this may comprise either an autonomous cooling system of the generator unit, for example an air or liquid cooling system, or a connection to a cooling circuit on the vehicle side. In a preferred arrangement, the generator unit has its own coolant pump, which forwards the coolant between cooling components, such as for example at least one generator and the control electronics unit, and a heat exchanger or a cooler. Thereby, the heat exchanger or cooler may be housed in the generator unit or in the commercial vehicle, Finally, a cooling system through working hydraulic fluid of the commercial vehicle or the add-on device is also conceivable.

In an additional form of the invention, a lubrication circuit is provided. Such an arrangement has the advantage that, through providing an appropriate supply of lubrication, moving parts of the generator unit (such as, for example, elements of an intermediate gear) can be reliably lubricated, and their wear can thus be reduced. Preferably, the lubrication circuit is thereby formed as oil lubrication with a pump and an oil sump. However, as an alternative to this, a design as an oil splash lubrication system is also conceivable.

The invent on is riot limited to the specified combinations of the characteristics of the principal claim or the dependent claims. There are also options for combining individual characteristics with one another, and as they arise from the claims, the following description of the embodiments or directly from the drawings. Any reference of the claims to the drawings through the use of reference signs should not restrict the scope of protection of the claims.

Additional, advantageous arrangements of the invention arise from the following description of preferred embodiments of the invention, which makes reference to the figures shown in the drawings. The following is shown:

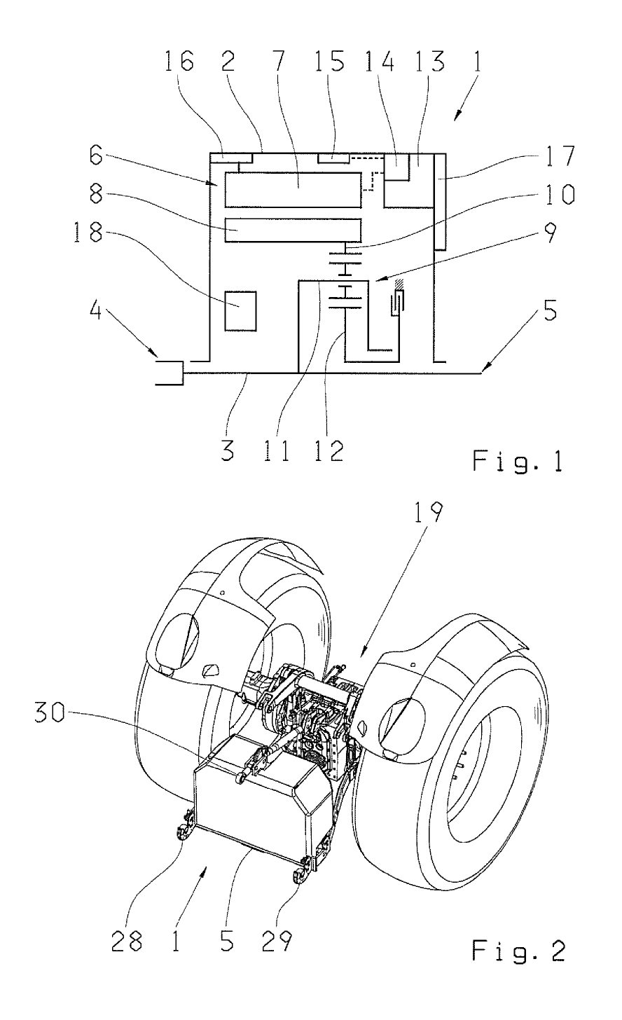

FIG. 1 a schematic representation of a generator unit under the invention according to a first preferred embodiment of the invention;

FIG. 2 a perspective representation in the area of the power lift of a commercial vehicle, on which the generator unit under the invention in accordance with FIG. 1 is attached;

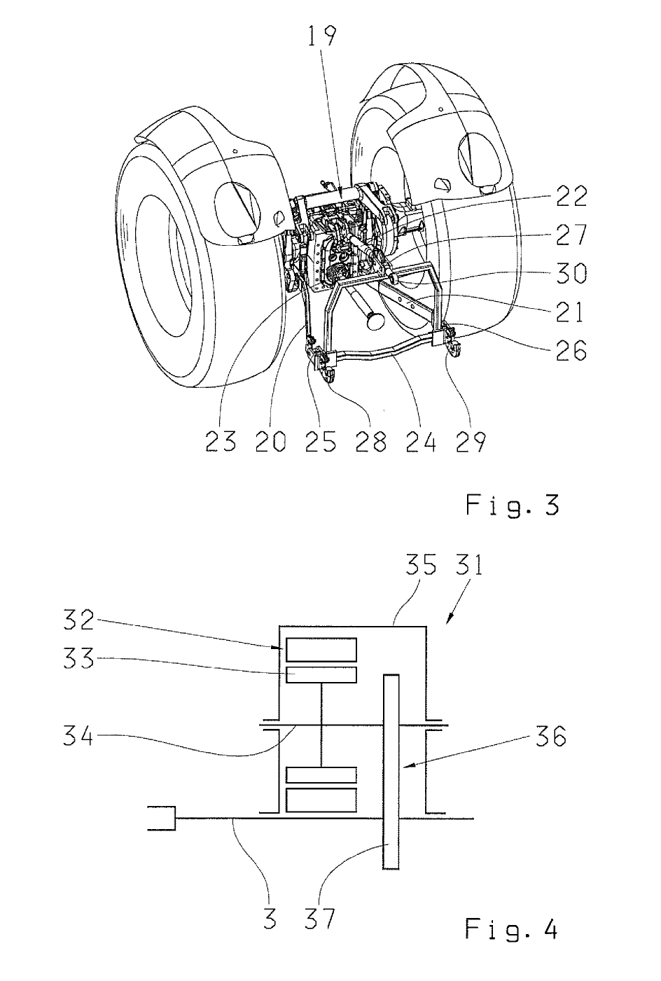

FIG. 3 an additional perspective view in he area of the power lift; and

FIG. 4 a schematic representation of a generator unit under the invention in accordance with a second preferred arrangement option of the invention.

FIG. 1 shows a schematic representation of a generator unit 1 under the invention in accordance with a first preferred embodiment of the invention. This generator unit 1 thereby comprises a generator housing 2, in which a shaft 3 is pivoted. Thereby, this shaft 3 forms, at a first end, a coupling in the form of an internally toothed shaft section, through which, for an arrangement of the generator unit 1 in the area of the power lift of a commercial vehicle, a coupling may take place at a power take-off shaft of the commercial vehicle, and for this purpose is provided with a spline shaft toothing or involute profile toothing corresponding to the respective power take-off shaft. However, at one end of the shaft 3 opposite to the coupling 4, a port 5 is defined for the connection of an input shaft of an add-on device, whereas such port 5 thereby features a profile corresponding to the respective power take-off shaft of the commercial vehicle, such that, instead of a direct connection to the power take-off shaft, a connection to the port 5 is easily possible. Thereby, the port 5, with regard to the coupling 4, is provided at an opposing side of the generator housing 2, whereas for this purpose the shaft 3 is passed through the generator housing 2.

As is further shown in FIG. 1, the generator housing 2 also incorporates an electrical generator 6 situated in a coaxial manner to shaft 3, the stator 7 of which is arranged in a stationary manner in the generator housing 2. Thereby, a rotor 8 is provided in the radial internal area of the stator 7; with this, upon a rotary movement, voltage in the stationary stator 7 is induced and electrical energy is thus generated. In order to then initiate the rotary movement of the rotor 8, the rotor shaft 8 is connected to the shaft 3 through the intermediate gear 9, which in the present case is formed as a planetary gear. Thereby, the rotor 8 is connected to a ring gear 10 of the gear, while the shaft 3 is coupled with a planetary bar 11, and a sun gear 12 may be fixed at the generator housing 2 through a brake. A transmission of the gear 9 is thereby selected in such a manner that, for the rotary movement of the shaft 3 corresponding to the power take-off shaft rotation speed, a rotary movement of the rotor 8 is induced, which is optimally selected for the generator 6. Accordingly, it is possible to use as a generator 6 a compact-constructed and high-speed electric motor, which produces an electric current with a voltage level suitable for an add-on device.

Furthermore, a control electronics unit 13, which is provided for the actuation of the generator 6, is incorporated in the housing 2. This control electronics unit 13 thereby comprises a control device 14, through which the generator 6 is governed, and which may be connected through a data interface 15 formed on the generator housing 2 to the commercial vehicle and, if applicable, also to an add-on device via a data bus. Through this data interface 15, a governing strategy of the generator 6 can be correspondingly coordinated with a governing system on the part of the vehicle and/or the part of the add-on device, whereas, through the control device 14, a targeted switching of the generator 6 is also possible through the fixing of the sun gear 12 by means of the actuation of the brake.

Furthermore, the stator 7 is in connection with an output interface 16, through which the electrical power produced by the generator 6 may be supplied to electrical devices or drives of the add-on device. Thereby, this output interface 16 is directly connected to the generator 6, such that AC voltage with generator frequency is accessible on the output interface 16. In addition, a cooling system 17 and a lubrication circuit 18 are incorporated in the generator housing 2; for reasons of clarity, both are shown only very schematically. Through the cooling system 17, a cooling of the generator 6 and also the control electronics unit 13 may be effected, whereas in the present case the cooling system 17 is carried out as an air cooling system, for example through corresponding cooling fins on the generator housing 2. However, a lubrication of the moving parts of the gear 9 is accomplished via the lubrication circuit 18, whereas, for this purpose, the lubrication circuit 18 may have, for example, a pump and an oil sump, which meters the lubricant in a targeted manner.

In order to then be able to correspondingly design the generator housing 2 for incorporating a large-scale and high-performance generator 6, the connection of the generator unit 1 takes place on a commercial vehicle by means of a particular arrangement outside of the generator housing 2, which is to be more specifically described with the assistance of FIG. 2 and FIG. 3:

In FIG. 2, the generator unit 1 under the invention is connected to a rear power lift 19 of a commercial vehicle in the form of a tractor. This three-point power lift 19 features a structure known to the specialist, and consists of two lower links 20 and 21 and one upper link 22, which in particular can be seen in FIG. 3, in which the generator housing 2 has been omitted for reasons of clarity. From the power lift 19, the lines 20, 21 and 22 are able to be lifted or lowered through the hydraulic cylinder (not shown in the present drawing), such that the working height of the power lift 19 is adjustable. Moreover, the upper link 22 is carried out as a threaded spindle, through the targeted change of length of which the gradient of a device arranged on the power lift 19 is adjustable.

In the present case, the generator unit 1 is then attached to the power lift 19, whereas the shaft 3 of the generator unit 1, of which only the port 5 can be seen in FIG. 2, is connected through the coupling 4 to a power take-off shaft 23 of the commercial vehicle, which can be seen in FIG. 3. In order to then be able to use the power lift 19, despite the intermediate generator housing 2, for the incorporation of an additional add-on device, whereas, through the generator unit 1, in this case electrical energy is made available for operating individual devices or drives of this add-on device, the generator unit 1 possesses a mounting device in the form of a support frame 24, the structure of which is particularly shown in FIG. 3. This support frame 24 is thereby designed as a separate component, to which the generator housing 2 is attached. In addition, the support frame 24 has a triangular form, whereas, in the area of the corner points of this triangle, mounting points 25, 26 and 27 are formed on the side of the generator housing 2 facing the commercial vehicle and lying on the side of the coupling 4, through which a connection of the generator unit 1 is presented on the lower links 20 and 21 and on the upper link 22 of the power lift 19. Such mounting points are thereby carried out as mounting pins, which correspond to the respective arresting hooks of the lower link 20 and 21 and the upper link 22. Accordingly, the generator unit 1 may be hooked to the power lift 19 through the mounting points 25 to 27.

However, the support frame 24 on the side of the port 5 of the generator housing 2 likewise forms connection points 28, 29 and 30 in the area of corner points of the triangle, which may be attached to the other add-on device to be specified, and which thereby corresponds in form and alignment to the respective arresting hooks of the lower links 20 and 21 and the upper link 22. Thereby, the connection points 28 to 30 are arranged as mounting hooks, whereas a mounting hook of the connection point 28 corresponds to the arresting hook of the lower link 20, a mounting hook of the connection point 29 corresponds to the arresting hook of the lower link 21 and a mounting hook of the connection point 30 corresponds to the arresting hook of the upper link 22, regarding form and alignment. As a result, the additional add-on device may be arranged on the support frame 24 in the same manner as would also be possible directly on the present power lift 19. Accordingly, without sacrificing functionality, the generator unit 1 may be placed between the power lift 19 and the respective add-on device.

FIG. 4 shows a second preferred arrangement option of a generator unit 31 under the invention. In contrast to the variant described above, a generator 32 in this case is not arranged in a coaxial manner to the shaft 3; rather, it is placed in a manner offset to the axis, by connecting a rotor 33 of the generator 32 to a rotor shaft 34 running parallel to the shaft 3. Thereby, this generator shaft 34, just like the shaft 3, is pivoted in a generator housing 35, and is also connected to the shaft 3 through an intermediate gear 36 in the form of a traction mechanism drive by means of a chain 37. Thereby, through this traction mechanism drive, a rotary movement of the shaft 3 is correspondingly transmitted to the rotor shaft 34. However, in all other respects, the arrangement in accordance with FIG. 4 is formed the same as the variant described above.

By means of the arrangements under the invention of a generator unit 1 or 31, as the case may be, it is thus possible to arrange high-performance and large-scale electrical generators 6 or 32, as the case may be, as mobile units on a power lift 19, and thereby nevertheless continue to use this power lift 19 for the arrangement of an additional add-on device.

### REFERENCE SIGNS

1 Generator unit
2 Generator housing
3 Shaft
4 Coupling
5 Port
6 Generator
7 Stator
8 Rotor
9 Gear
10 Ring gear
11 Planetary bar
12 Sun gear
13 Control electronics unit
14 Control device
15 Data interface
16 Output interface
17 Cooling system
18 Lubrication circuit
19 Power lift
20 Lower link
21 Lower link
22 Upper link
23 Power take-off shaft
24 Support frame
25 Mounting point
26 Mounting point
27 Mounting point
29 Connection point
30 Connection point
31 Generator unit
32 Generator
33 Rotor
34 Rotor shaft
35 Generator housing
36 Gear
37 Chain

1. Generator unit (1; 31) for an agricultural or municipal commercial vehicle, in particular a tractor, comprising a generator housing (2; 35) and at least one shaft (3), which is passed in a rotating manner through the generator housing (2; 35) and forms a coupling (4) for a power take-off shaft (23) of the commercial vehicle at the first end, while a port (5) for an input shaft of an add-on device is defined through at least one shaft (3) at a second end, whereas at least one electrical generator (6; 32), which is able to be driven through at least one shaft (3), is incorporated in the generator housing (2; 35), characterized in that a mounting device is also provided; this is connected to the generator housing and, on the part of the first end of at least one shaft (3), forms mounting points (25, 26, 27) for connecting to suspension devices of the power lift (19) of the commercial vehicle, whereas the mounting device, on the part of the second end of at least one shaft (3), possesses connection points (28, 29, 30) for the incorporation of the add-on device, whereas the connection points (28, 29, 30) of the mounting device correspond to the suspension devices of the power lift (19), in each case in form and alignment.

2-10. (canceled)
